(19) United States
(12) Patent Application Publication
(10) Pub. No.: US 2021/0056414 A1
(43) Pub. Date: Feb. 25, 2021

(54) LEARNING APPARATUS, LEARNING METHOD, AND PROGRAM FOR LEARNING APPARATUS, AS WELL AS INFORMATION OUTPUT APPARATUS, INFORMATION OUPUT METHOD, AND INFORMATION OUTPUT PROGRAM

(71) Applicant: NATIONAL UNIVERSITY CORPORATION HOKKAIDO UNIVERSITY, Sapporo-shi, Hokkaido (JP)

(72) Inventors: Miki HASEYAMA, Sapporo-shi, Hokkaido (JP); Takahiro OGAWA, Sapporo-shi, Hokkaido (JP)

(73) Assignee: NATIONAL UNIVERSITY CORPORATION HOKKAIDO UNIVERSITY, Sapporo-shi, Hokkaido (JP)

(21) Appl. No.: 16/966,744

(22) PCT Filed: Jan. 31, 2019
(86) PCT No.: PCT/JP2019/003420

§ 371 Date: Sep. 2, 2020

(30) Foreign Application Priority Data
Feb. 2, 2018 (JP) 2018-017044

(51) Int. Cl. G06N 3/08; G06K 9/62

(52) U.S. Cl. CPC G06N 3/08; G06K 9/6232; G06K 9/6267; G06K 9/6257

(57) ABSTRACT

Provided is a learning apparatus capable of generating learning pattern information for causing meaningful output information corresponding to input information to be accurately output, while reducing the amount of learning data needed to generate the learning pattern corresponding to the input information. When generating learning pattern data PD for obtaining meaningful output corresponding to image data GD, the learning pattern data PD corresponding to the results of deep-layer learning processing using the image data GD, the learning apparatus: acquires, from an external source, external data BD corresponding to the image data GD; on the basis of a correlation between image feature data GC indicating a feature of the image data GD and external feature data BC indicating a feature of the external data BD, converts the image feature data GC; and generates converted image feature data MC. Subsequently, the generated converted image feature data MC is used to execute deep-layer learning processing, and learning pattern data PD is generated.

### TECHNICAL FIELD

The present invention belongs to the technical field of a learning apparatus, a learning method and a program for the learning apparatus, and an information output apparatus, an information output method, and a program for the information output apparatus. More specifically, it belongs to the technical field of a learning apparatus, a learning method, and a program for the learning apparatus for generating learning pattern information for outputting significant output information corresponding to input information such as image information, and an information output apparatus, an information output method, and an information output program for information output for outputting output information using the generated learning pattern information.

### BACKGROUND ART

In recent years, research on machine learning, especially deep learning has been actively conducted. Prior art documents disclosing such research include, for example, Non-Patent Document 1 and Non-Patent Document 2 below. In these researches, extremely accurate recognition and classification are possible.

### CITATION LIST

### Non Patent Documents

Non-Patent Document 1; Y. LeCun, Y. Bengio, and G. Hinton, “Deep learning”, Nature, vol. 521, pp. 436-444, 2015
Non-Patent Document 2: J. Schmidhuber, “Deep learning in neural networks: An overview”, Neural Networks, vol. 61, pp. 85-117, 2015

### DISCLOSURE OF INVENTION

### Problems to be Solved by the Invention

However, for the techniques described in the two non-patent documents above, problems are pointed out in which, in order to improve the accuracy of the above-described recognition and classification, a large amount of learning data, e.g., 100,000 units, is required, and the process with respect to recognition and classification results is very different from that of humans. Then, at present, the technique to solve these problems simultaneously has not been realized yet. Further, these problems become prominent in issues related to individual preferences and expertise, and they are also a barrier when considering practical use of deep learning.

Note that as a method for enabling learning from a small amount of learning data, a method so-called “fine-tuning” in which learning is performed again from a learned discriminator or the like is known, but there is a limitation on the reduction of the amount of learning data, and it is difficult to achieve improvement in learning accuracy together.

Therefore, the present invention has been made in view of each of the above problems, and an example of the object is to provide a learning apparatus, a learning method, and a program for the learning apparatus that can reduce the above-described learning data by reducing the number of layers of the above-described deep learning and the number of patterns of learning pattern as a result of the deep learning, and an information output apparatus, an information output method, and an information output program that can output the above-described output information using generated learning pattern information.

### Solutions to the Problems

In order to solve the above described object, an invention according to claim 1 is a learning apparatus generating learning pattern information for outputting significant output information corresponding to input information on the basis of the input information, the learning pattern information corresponding to a result of deep learning processing using the input information, the learning apparatus comprising: an external information acquisition means, such as an input interface or the like, that externally acquires external information corresponding to the input information; a transformation means, such as a transformation unit or the like, that transforms input feature information on the basis of a correlation between the input feature information indicating a feature of the input information and external feature information indicating a feature of the acquired external information, and generates transformed input feature information; and a deep learning means, such as a learning parameter determination unit or the like, that executes the deep learning processing using the generated transformed input feature information, and generates the learning pattern information.

In order to solve the above described object, an invention according to claim 6 is a learning method executed in a learning apparatus generating learning pattern information for outputting significant output information corresponding to input information on the basis of the input information, the learning pattern information corresponding to a result of deep learning processing using the input information, the learning apparatus comprising an external information acquisition means such as an input interface or the like, a transformation means such as a transformation unit or the like, and a deep learning means such as a learning parameter determination unit or the like, the learning method comprising: an external information acquisition step of externally acquiring external information corresponding to the input information by the external information acquisition means; a transformation step of transforming input feature information by the transformation means on the basis of a correlation between the input feature information indicating a feature of the input information and external feature information indicating a feature of the acquired external information, and generating transformed input feature information; and a deep learning step of executing the deep learning processing by the deep learning means using the generated transformed input feature information, and generating the learning pattern information.

In order to solve the above described object, an invention according to claim 7 is a program for a learning apparatus for causing a computer included in a learning apparatus generating learning pattern information for outputting significant output information corresponding to input information on the basis of the input information, the learning pattern information corresponding to a result of deep learning processing using the input information, to function as: an external information acquisition means that externally acquires external information corresponding to the input information; a transformation means that transforms input feature information on the basis of a correlation between the input feature information indicating a feature of the input information and external feature information indicating a feature of the acquired external information, and generates transformed input feature information; and a deep learning means that executes the deep learning processing using the generated transformed input feature information, and generates the learning pattern information.

According to the invention described in any one of claims 1, 6, and 7, by generating the learning pattern information using the correlation with external information corresponding to input information, it is possible to reduce the number of layers in deep learning processing for generating learning pattern information corresponding to the input information and the number of patterns, which is as the learning pattern information. Therefore, it is possible to output significant output information corresponding to the input information while reducing the amount of input information, which is as learning data necessary for generating the learning pattern information.

In order to solve the above described object, an invention according to claim 2 is the learning apparatus according to claim 1, wherein the external information is external information that is electrically generated due to an activity of a person related to generation of the output information using the generated learning pattern information, the activity relating to the generation.

According to the invention described in claim 2, in addition to the operation of the invention described in claim 1, because the external information is external information electrically generated due to the activity of a person involved in the generation of the output information using the learning pattern information, it is possible to generate learning pattern information corresponding to both the person's specialty and preference and the input information.

In order to solve the above described object, an invention according to claim 3 is the learning apparatus according to claim 2, wherein the external information includes at least one of brain activity information corresponding to a brain activity of the person generated by the activity and visual recognition information corresponding to a visual recognition action of the person included in the activity.

According to the invention described in claim 3, in addition to the operation of the invention described in claim 2, because the external information includes at least one of brain activity information corresponding to the brain activity of a person generated by the activity of the person involved in the generation of output information using the learning pattern information and visual recognition information corresponding to a visual recognition action of the person included in the activity, it is possible to generate learning pattern information more corresponding to the specialty or preference of the person.

In order to solve the above described object, an invention according to claim 4 is the learning apparatus according to any one of claims 1 to 3, wherein the correlation is a correlation, which is a result of canonical correlation analysis processing between the input feature information and the external feature information, and the transformation means transforms the input feature information on the basis of the result and generates the transformed input feature information.

According to the invention described in claim 4, in addition to the operation of the invention described in any one of claims 1 to 3, because input feature information is transformed on the basis of the result of canonical correlation analysis processing between the input feature information and external feature information to generate transformed input feature information, it is possible to generate the transformed input feature information that is more correlated with the external information and use the transformed input feature information for generation of the learning pattern information.

In order to solve the above described object, an invention according to claim 5 is an information output apparatus outputting the output information using the learning pattern information generated by the learning apparatus according to any one of claims 1 to 4, the information output apparatus comprising: a storage means, such as a storage unit or the like, that stores the generated learning pattern information; an acquisition means, such as an input interface or the like, that acquires the input information; and an output means, such as a classification unit or the like, that outputs the output information corresponding to the input information on the basis of the acquired input information and the stored learning pattern information.

In order to solve the above described object, an invention according to claim 8 is an information output method executed in an information output apparatus outputting the output information using the learning pattern information generated by the learning apparatus according to any one of claims 1 to 4, the information output apparatus comprising a storage means, such as a storage unit or the like, that stores the generated learning pattern information, an acquisition means such as an input interface or the like, and an output means such as a classification unit or the like, the information output method comprising: an acquisition step of acquiring the input information by the acquisition means; and an output step of outputting the output information corresponding to the input information by the output means on the basis of the acquired input information and the stored learning pattern information.

In order to solve the above described object, an invention according to claim 9 is an information output program for causing a computer included in an information output apparatus outputting the output information using the learning pattern information generated by the learning apparatus according to any one of claims 1 to 4, to function as: a storage means that stores the generated learning pattern information; an acquisition means that acquires the input information; and an output means that outputs the output information corresponding to the input information on the basis of the acquired input information and the stored learning pattern information.

According to the invention described in any one of claims 5, 8, and 9, in addition to the operation of the invention described in any one of claims 1 to 4, because, on the basis of input information and stored learning pattern information, output information corresponding to the input information is output, it is possible to output output information more corresponding to the input information.

### Effects of the Invention

According to the present invention, by generating the learning pattern information using the correlation with external information corresponding to input information, it is possible to reduce the number of layers in deep learning processing for generating learning pattern information corresponding to the input information and the number of patterns, which is as the learning pattern information.

Therefore, it is possible to accurately output significant output information corresponding to input information while reducing the amount of input information, which is as learning data necessary for generating the learning pattern information.

### BRIEF DESCRIPTION OF THE DRAWINGS

FIG. 1 is a block figure showing a schematic configuration of a deterioration determination system according to an embodiment.

FIG. 2 is a block figure showing a detailed configuration of a learning apparatus included in the deterioration determinations system according to the embodiment.

FIG. 3 is a conceptual figure showing a canonical correlation analysis processing in learning processing according to the embodiment.

FIG. 4 is a conceptual figure showing entire learning processing according to the embodiment.

FIG. 5 is a block figure showing a detailed configuration of an inspection apparatus included in the deterioration determination system according to the embodiment.

FIG. 6 is a flowchart showing deterioration determination processing according to the embodiment, (a) is a flowchart showing learning processing according to the embodiment, and (b) is a flowchart showing inspection processing according to the embodiment.

### EMBODIMENTS FOR CARRYING OUT THE INVENTION

Next, a mode for carrying out the present invention will be described on the basis of the drawings. Note that the embodiment described below is an embodiment in a case where the present invention is applied to a deterioration determination system that determines the state of deterioration of a building or structure such as a pier using image data obtained by photographing their appearance. At this time, in the following description, the above-described building or structure is simply referred to as “structure”.

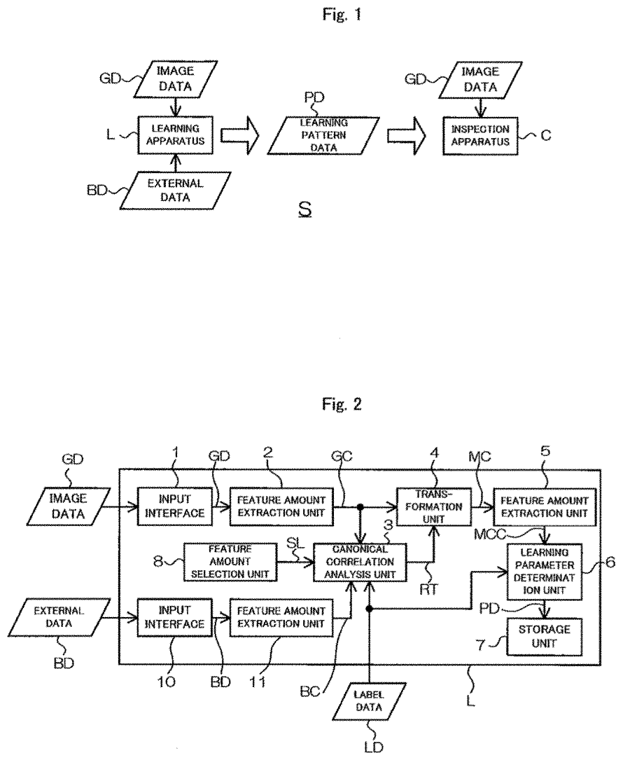

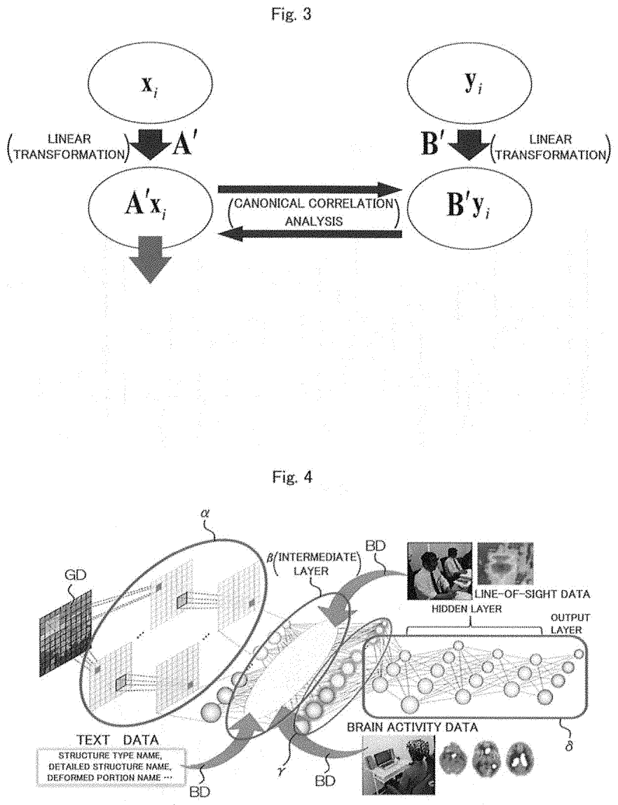

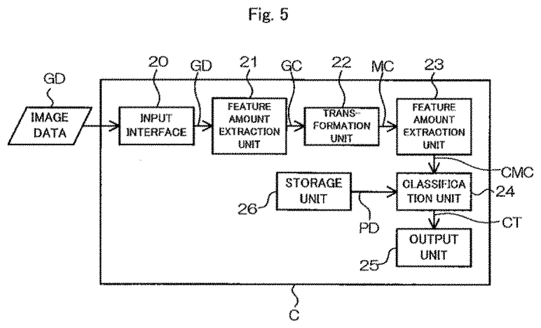

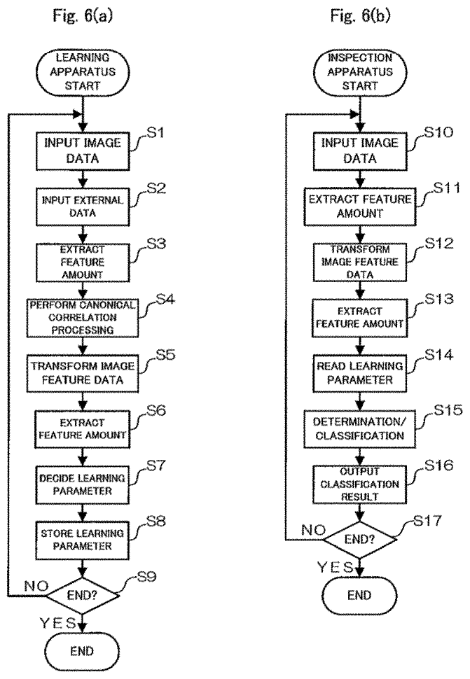

Further, FIG. 1 is a block figure showing a schematic configuration of a deterioration determination system according to the embodiment, and FIG. 2 is a block figure showing a detailed configuration of a learning apparatus included in the deterioration determination system. Moreover, FIG. 3 is a conceptual figure showing a canonical correlation analysis processing in learning processing according to the embodiment, and FIG. 4 is a conceptual figure showing the entire learning processing. Moreover, FIG. 5 is a block figure showing a detailed configuration of an inspection apparatus included in the deterioration determination system according to the embodiment, and FIG. 6 is a flowchart showing deterioration determination processing according to the embodiment.

### (I) Overall Configuration and Operation of the Determination System

First, the overall configuration and operation of the determination system according to the embodiment will be described with reference to FIG. 1.

As shown in FIG. 1, a determination system S according to the embodiment comprises a learning apparatus L and an inspection apparatus C. At this time, the learning apparatus L corresponds to an example of the “learning apparatus” according to the present invention, and the inspection apparatus C corresponds to an example of the “information output apparatus” according to the present invention.

In this configuration, the learning apparatus L, on the basis of image data GD obtained by previously photographing a structure, which is a target of deterioration determination, and external data BD corresponding to the deterioration determination using the image data GD, generates learning pattern data PD for automatically performing the above-described deterioration determination by deep learning processing using the image data GD, which is a new target of the deterioration determination. Then, the generated learning pattern data PD is stored in a storage unit of the inspection apparatus C actually used for the deterioration determination.

On the other hand, at the time of the actual deterioration determination of the structure using the above-described learning pattern data PD, the inspection apparatus C performs deterioration determination using the result of the above-described deep learning processing by using the learning pattern data PD stored in the above-described storage unit and the image data GD obtained by newly photographing the structure, which is a target of the deterioration determination. At this time, the structure, which is a target of the actual deterioration determination, may be different from or the same as the structure for which the image data GD used for the deep learning processing in the learning apparatus L is photographed.

### (II) Detailed Configuration and Operation of the Learning Apparatus

Next, the configuration and operation of the above-described learning apparatus L will be described with reference to FIGS. 2 to 4.

As shown in FIG. 2, the learning apparatus L according to the embodiment is basically realized by a personal computer or the like, and functionally comprises an input interface 1, an input interface 10, a feature amount extraction unit 2, a feature amount extraction unit 5, a feature amount extraction unit 11, a canonical correlation analysis unit 3, a transformation unit 4, a learning parameter determination unit 6, a storage unit 7, and a feature amount selection unit 8. Note that the feature amount extraction unit 2, the feature amount extraction unit 5, the feature amount extraction unit 11, the canonical correlation analysis unit 3, the transformation unit 4, the learning parameter determination unit 6, the storage unit 7, and the feature amount selection unit 8 may be configured as a hardware logic circuit including, for example, a CPU or the like comprised in the learning apparatus L, or may be achieved like software as a program corresponding to learning processing (see FIG. 6(a)) according to an embodiment described later is read and executed by the above-described CPU or the like of the learning apparatus L. Further, the above-described input interface 10 corresponds to an example of the “external information acquisition means” according to the present invention, and the feature amount extraction unit 2 and the transformation unit 4 correspond to an example of the “transformation means” according to the present invention. The feature amount extraction unit 5 and the learning parameter determination unit 6 correspond to an example of the “deep learning means” according to the present invention.

With the above configuration, the image data GD, which is as learning data, obtained by photographing the structure, which is a target of the previous deterioration determination, is output to the feature amount extraction unit 2 via the input interface 1. Then, the feature amount extraction unit 2 extracts the feature amount in the image data GD by an existing feature amount extraction method, generates image feature data GC, and outputs it to the canonical correlation analysis unit 3 and the transformation unit 4.

On the other hand, the external data BD, which is an example of the “external information” according to the present invention, is output to the feature amount extraction unit 11 via the input interface 10. Here, examples of the data included in the above-described external data BD include brain activity data showing the state of brain activity at the time of deterioration determination of a person who has made the deterioration determination of the structure corresponding to the above-described image data GD (for example, a determiner who has a certain degree of skill of deterioration determination); line-of-sight data showing the movement of the line of sight of the person at the time of the deterioration determination; text data indicating a structure type name, a detailed structure name, a deformed portion name, and the like of the structure, which is a target of the deterioration determination; and the like. At this time, as the above-described brain activity data, brain activity data measured by using so-called functional near-infrared spectroscopy (fNIRS) can be used as an example. Further, the above-described text data is text data that does not include the content as label data LD, which will be described later, and is various text data that can be used for the canonical correlation analysis processing by the canonical correlation analysis unit 3. Then, the feature amount extraction unit 11 extracts the feature amount in the external data BD by an existing feature amount extraction method, generates external feature data BC, and outputs it to the canonical correlation analysis unit 3. On the other hand, the label data LD indicating the classification (classification class) of the state of deterioration of the above-described structure and for classification of the result of deep learning processing described later by the learning parameter determination unit 6 is input to the canonical correlation analysis unit 3 and the learning parameter determination unit 6. By these, the canonical correlation analysis unit 3, on the basis of the label data LD, the external feature data BC, and the image feature data GC, executes the canonical correlation analysis processing between the external feature data BC and the image feature data GC, and outputs the result (that is, the canonical correlation between the external feature data BC and the image feature data GC) to the transformation unit 4 as analysis result data RT. Then, the transformation unit 4 transforms the image feature data GC using the analysis result data RT and outputs the resulting data as transformed image feature data MC to the feature amount extraction unit 5.

Here, the overview of the above-described canonical correlation analysis processing by the canonical correlation analysis unit 3 and the transformation processing by the transformation unit 4 using the analysis result data RT, which is a result of the canonical correlation analysis processing, will be described with reference to FIG. 3.

In general, the canonical correlation analysis processing is processing for obtaining a transformation that maximizes, for example, the correlation between two variables (variables such as vectors). That is, in FIG. 3, assuming that there are two vectors xᵢ and yᵢ (i=1, 2, . . . , N (N is the number of data samples)), in the canonical correlation analysis processing, “a transformation that maximizes the correlation between the two vectors xᵢ and yᵢ” is obtained using linear transformation by a transposed matrix A′ and transposed matrix B′ shown in FIG. 3. At this time, the above-described correlation is called the above-described “canonical correlation”. By this canonical correlation analysis processing, it is possible to obtain the intrinsic relationship between the original vector xᵢ and the vector yᵢ. Note that although FIG. 3 shows a case where linear transformation is performed using the transposed matrix A′ and the transposed matrix B′, non-linear transformation may be used. Then, in the learning processing according to the embodiment, the above-described analysis result data RT (corresponding to a new vector A′Xᵢ shown in FIG. 3) is used to transform the image feature data GC by the transformation unit 4 so as to indicate the canonical correlation between the external feature data BC and the image feature data GC. Note that the transformation by the transformation unit 4 in this case may correspond to the canonical correlation including the above-described linear transformation as well as the canonical correlation including the above-described non-linear transformation. Thus, the transformation that maximizes the correlation with the external data BD is taken into the deep learning processing for the original image data GD. At this time, in a case where the above-described brain activity data is used as the external data BD, the brain activity data includes information indicating the expertise and preference of a person who is the source of acquisition of the brain activity data. Therefore, the feature amount as an image capable of expressing (embodying) the expertise and preference is output as the transformed image feature data MC which is the transformation result of the transformation unit 4. At this time, in the canonical correlation analysis processing by the canonical correlation analysis unit 3, the feature amount selection unit 8 switches the external feature data BD based on a canonical correlation coefficient used for the canonical correlation analysis processing, and uses it for the canonical correlation analysis processing.

Next, the feature amount extraction unit 5 extracts the feature amount in the transformed image feature data MC again by the existing feature amount extraction method, generates learning feature data MCC, and outputs it to the learning parameter determination unit 6. Thus, the learning parameter determination unit 6 performs deep learning processing using the learning feature data MCC as learning data on the basis of the above-described label data LD, generates learning pattern data PD as a result of the deep learning processing, and outputs it to the storage unit 7. Then, the storage unit 7 stores the learning pattern data PD in a storage medium, which is not shown, (for example, a storage medium such as a USB (universal serial bus) memory or an optical disk).

Here, the overall learning processing according to the embodiment in the learning apparatus L described above is conceptually shown in FIG. 4. Note that FIG. 4 is a figure showing the deep learning processing (deep learning processing including an intermediate layer, a hidden layer, and an output layer shown in FIG. 4) according to the embodiment using, for example, a fully connected neural network. That is, in the learning processing according to the embodiment, when the image data GD obtained by previously photographing the structure, which is a target of the deterioration determination, is input to the learning apparatus L, the feature amount extraction unit 2 extracts the feature amount and generates the image feature data GC. This processing corresponds to the processing indicated by the symbol a in FIG. 4. Next, with respect to the image feature data GC, transformation processing including the above-described canonical correlation processing using the brain activity data, the line-of-sight data and/or the text data, which are as the external data BD, and the above-described label data LD is executed by the canonical correlation analysis unit 3 and the transformation unit 4, and the above-described transformed image feature data MC is generated. This processing corresponds to the processing indicated by the symbol R in FIG. 4 (canonical correlation analysis processing) and the processing of a node part indicated by the symbol γ. Then, feature amount extraction processing by the feature amount extraction unit 5 from the generated transformed image feature data MC, and processing of generating learning pattern data PD by the learning parameter determination unit 6 using the resulting learning feature data MCC are executed. These processing correspond to the processing indicated by the symbol 6 in FIG. 4. At this time, the generated learning pattern data PD includes learning parameter data corresponding to the intermediate layer shown in FIG. 4 and learning parameter data corresponding to the hidden layer shown in FIG. 4. Then, the generated learning pattern data PD is stored in the above-described storage medium, which is not shown, by the storage unit 7. With the learning processing according to the embodiment described above, by using the brain activity data or the like indicating the state of the brain activity of the person who has performed the same deterioration determination in the past as the external data BD, for example, while omitting the portion of the deep learning processing corresponding to the brain activity of the person, the deterioration determination reflecting the specialty of the person can be performed by the inspection apparatus C, and the amount of the image data GD as the learning data can be reduced significantly.

### (III) Detailed Configuration and Operation of the Inspection Apparatus

Next, the configuration and operation of the above-described inspection apparatus C will be described with reference to FIG. 5.

As shown in FIG. 5, the inspection apparatus C according to the embodiment basically comprises, for example, a portable or movable personal computer or the like, and functionally comprises an input interface 20, a feature amount extraction unit 21, a feature amount extraction unit 23, a transformation unit 22, a classification unit 24, an output unit 25 including a liquid crystal display or the like, and a storage unit 26. Note that the feature amount extraction unit 21, the feature amount extraction unit 23, the transformation unit 22, the classification unit 24, and the storage unit 26 may be configured as a hardware logic circuit including, for example, a CPU or the like comprised in the inspection apparatus C, or may be achieved like software as a program corresponding to inspection processing (see FIG. 6(b)) according to an embodiment described later is read and executed by the above-described CPU or the like of the inspection apparatus C. Further, the above-described input interface 20 corresponds to an example of the “acquisition means” according to the present invention, the classification unit 24 and the output unit 25 correspond to an example of the “output means” according to the present invention, and the storage unit 26 corresponds to an example of the “storage means” according to the present invention.

In the above configuration, the learning pattern data PD stored in the above-described storage medium by the learning apparatus L is read from the storage medium and stored in the storage unit 26. Then, the image data GD, which is an example of the “input information” according to the present invention, which is the image data GD obtained by photographing the structure, which is newly a target of the deterioration determination by the inspection apparatus C, is input to the feature amount extraction unit 21 via, for example, a camera or the like, which is not shown, and the input interface 20. Thus, the feature amount extraction unit 21 extracts the feature amount in the image data GD by an existing feature amount extraction method, which is, for example, the same as that of the feature amount extraction unit 2 of the learning apparatus L, generates image feature data GC, and outputs it to the transformation unit 22. Then, the transformation unit 22 performs transformation processing including canonical correlation analysis processing using the above-described transposed matrix A′ and transposed matrix B′, which is, for example, the same as that of the transformation unit 4 of the learning apparatus L, on the image feature data GC, and outputs the data to the feature amount extraction unit 23 as the transformed image feature data MC. Note that information necessary for the canonical correlation analysis processing including data indicating the transposed matrix A′ and the transposed matrix B′ is stored in advance in a memory, which is not shown, of the inspection apparatus C.

Next, the feature amount extraction unit 23 extracts again the feature amount in the transformed image feature data MC by an existing feature amount extraction method, which is, for example, the same as that of the feature amount extraction unit 5 of the learning apparatus L, generates feature data CMC, and outputs it to the classification unit 24. Then, the classification unit 24 reads the learning pattern data PD from the storage unit 26, uses it to determine and classify the state of deterioration of the structure indicated by the feature data CMC, and outputs it to the output unit 25 as classification data CT. By the classification processing in the classification unit 24 using the learning pattern data PD, it is possible to perform deterioration determination of the structure using the result of the deep learning processing in the learning apparatus L. Then, the output unit 25, for example, displays the classification data CT to make a user recognize the deterioration state or the like of the structure, which is newly a target of the deterioration determination.

### (IV) Deterioration Determination Processing According to the Embodiment

Finally, the deterioration determination processing according to the embodiment, which is executed in the entire determination system S according to the embodiment, will be collectively described with reference to FIG. 6.

First, within the deterioration determination processing according to the embodiment, the learning processing according to the embodiment executed by the learning apparatus L will be described with reference to FIG. 6(a).

The learning processing according to the embodiment executed by the learning apparatus L having the above-described detailed configuration and operation is started, for example, when the power switch of the learning apparatus L is turned on and furthermore the image data GD, which is the above-described learning data, is input to the learning apparatus L (step S1). Then, when the external data BD is input to the learning apparatus L in parallel with the image data GD (step S2), the above-described image feature data GC and the above-described external feature data BC are generated by the feature amount extraction unit 2 and the feature amount extraction unit 11, respectively (step S3). Then, the canonical correlation analysis processing using the image feature data GC, the external feature data BC, and the label data LD is executed by the canonical correlation analysis unit 3 (step S4), and the image feature data GC is transformed by the transformation unit 4 using the resulting analysis result data RT to generate the transformed image feature data MC (step S5). Then, the feature amount extraction unit 5 extracts the feature amount in the transformed image feature data MC, and the feature amount is output to the learning parameter determination unit 6 as the learning feature data MCC (step S6). Then, the above-described learning pattern data PD is generated by the deep learning processing of the learning parameter determination unit 6 (step S7), and further the learning pattern data PD is stored in the above-described storage medium by the storage unit 7 (step S8). Then, for example, by determining whether or not the above-described power switch of the learning apparatus L is turned off, it is determined whether or not to end the learning processing according to the embodiment (step S9). In a case where it is determined in step S9 that the learning processing according to the embodiment is to be ended (step S9: YES), the learning apparatus L ends the learning processing. On the other hand, in a case where it is determined in step S9 to continue the learning processing (step S9: NO), the processing of step S1 and subsequent steps described above is repeated thereafter.

Next, within the deterioration determination processing according to the embodiment, the inspection processing according to the embodiment executed by the inspection apparatus C will be described with reference to FIG. 6(b).

The inspection processing according to the embodiment executed by the inspection apparatus C having the above-described detailed configuration and operation is started, for example, when the power switch of the inspection apparatus C is turned on and furthermore new image data GD, which is a target of the above-described deterioration determination, is input to the inspection apparatus C (step S10). Then, the feature amount extraction unit 21 generates the above-described image feature data GC (step S11). Then, the image feature data GC is transformed by the transformation unit 22 to generate the transformed image feature data MC (step S12). Next, the feature amount extraction unit 23 extracts the feature amount in the transformed image feature data MC, and the feature amount is output as the feature data CMC to the classification unit 24 (step S13). Then, the above-described learning pattern data PD is read from the storage unit 26 (step S14), and the determination and classification of the deterioration of the structure using the learning pattern data PD is executed by the classification unit 24 (step S15). Then, the classification result is presented to the user via the output unit 25 (step S16). Then, for example, by determining whether or not the above-described power switch of the inspection apparatus C is turned off, it is determined whether or not to end the inspection processing according to the embodiment (step S17). In a case where it is determined in step S17 that the inspection processing according to the embodiment is to be ended (step S17: YES), the inspection apparatus C ends the inspection processing. On the other hand, in a case where it is determined in step S17 to continue the inspection processing (step S17: NO), the processing of step S10 and subsequent steps described above is repeated thereafter.

As described above, with the deterioration determination processing according to the embodiment, the learning apparatus L generates the learning pattern data PD by using the correlation with the external data BD corresponding to the image data GD, which is the learning data. Thus, the number of layers in the deep learning processing for generating the learning pattern data PD corresponding to the image data GD and the number of patterns as the learning pattern data PD can be reduced. Therefore, while reducing the amount of the image data GD (image data GD input to the learning apparatus L together with the external data BD), which is learning data necessary for generating the learning pattern data PD, it is possible to obtain a significant deterioration determination result corresponding to the image data GD (image data GD input to the inspection apparatus C).

Further, since the external data BD is the external data BD that is electrically generated due to the activity of the person involved in the deterioration determination using the learning pattern data PD, the learning pattern data PD corresponding to both the specialty of the person and the image data GD can be generated.

Moreover, in a case where the external data BD includes at least one of the brain activity data corresponding to the brain activity of the person caused by the activity of the person involved in the deterioration determination by using the learning pattern data PD and the visual recognition data corresponding to the visual recognition action of the person included in the activity, it is possible to generate the learning pattern data PD more corresponding to the specialty of the person.

Furthermore, because the image feature data GC is transformed on the basis of the result of the canonical correlation analysis processing between the image feature data GC and the external feature data BC to generate the transformed image feature data MC, it is possible to generate more correlated transformed image feature data MC by the external data BD and use it for generation of the learning pattern data PD.

Further, in the inspection apparatus C, the deterioration determination result corresponding to the image data GD is output (presented) on the basis of the new image data GD, which is the target of deterioration determination, and the stored learning pattern data PD, and therefore it is possible to output a deterioration determination result more corresponding to the image data GD.

Note that in the above-described embodiment, as the brain activity data of the person who has performed the deterioration determination of the structure corresponding to the image data GD, the brain activity data measured using the functional near-infrared spectroscopy is used. However, other than this, so-called EEG (electroencephalogram) data, simple electroencephalograph data, or fMRI (functional magnetic resonance imaging) data of the person may be used as the brain activity data. Other than this, as the external data BD, generally, as the external data BD indicating the specialty or preference of a person, blink data, voice data, vital data (blood pressure data, saturation data, heart rate data, pulse rate data, skin temperature data, or the like) of the person, or body movement data, and the like can be used.

Further, in the above-described embodiment, the present invention is applied to the case where the deterioration determination of the structure is performed using the image data GD, but other than this, the present invention may be provided to the case where the deterioration determination is performed by acoustic data (so-called keystroke sound). In this case, the learning processing according to the embodiment is executed by using the brain activity data of the person who has performed the deterioration determination based on the keystroke sound (that is, the determiner who has performed the deterioration determination by hearing the keystroke sound) as the external data BD.

Furthermore, in the above-described embodiment and the like, the present invention is applied to the case where the deterioration determination of the structure is performed by using the image data GD or the acoustic data, but other than this, the present invention can also be applied to the case where the determination of the state of various objects is performed by using corresponding image data or acoustic data.

Further, the present invention can be applied not only to the deterioration determination processing of the structure as in the embodiment and the like, but also to the case where medical diagnostic support or hanging down of a medical diagnostic technology is performed with using the learning pattern data obtained as a result of the deep learning processing reflecting the experience of a doctor, dentist, nurse, or the like, or the case where safety measure determination support or disaster risk determination support is performed using the learning pattern data obtained as a result of deep learning processing reflecting the experience of a disaster risk expert and the like.

Furthermore, in a case where the present invention is applied to learning of a person's preference, as the external data BD according to the embodiment, it is possible to use external data BD corresponding to the preference result (determination result) of a person having a similar preference.

Furthermore, in the above-described embodiment, the case where both the learning apparatus L and the inspection apparatus C are of a so-called stand-alone type has been described, but it is not limited to these, and the function of each of the learning apparatus L and the inspection apparatus C according to the embodiment may be configured to be realized on a system including a server apparatus and a terminal apparatus. That is, in the case of the learning apparatus L according to the embodiment, the functions of the input interface 1, the input interface 10, the feature amount extraction unit 2, the feature amount extraction unit 5, the feature amount extraction unit 11, the canonical correlation analysis unit 3, the transformation unit 4, and the learning parameter determination unit 6 in the learning apparatus L may be configured to be provided in a server apparatus connected to a network such as the Internet. In this case, it is preferable that the image data GD, the external data BD, and the label data LD be transmitted to the server apparatus (see FIG. 2) from a terminal apparatus connected to the network, and further the learning pattern data PD determined by the learning parameter determination unit 6 of the above-described server apparatus be transmitted from the server apparatus to the terminal apparatus and stored therein. On the other hand, in the case of the inspection apparatus C according to the embodiment, the functions of the input interface 20, the feature amount extraction unit 21, the feature amount extraction unit 23, the transformation unit 22, the classification unit 24, and the storage unit 26 in the inspection apparatus C may be configured to be provided in the above-described server apparatus. In this case, it is preferable to configure such that the image data GD, which is a target of determination, is transmitted to the server apparatus (see FIG. 5) from the terminal apparatus connected to the network, and further the classification data CT output from the classification unit 24 of the above-described server apparatus is transmitted from the server apparatus to the terminal apparatus and output (displayed).

### EXAMPLES

Next, the result of an experiment conducted by the inventors of the present invention as showing the effects of the deterioration determination processing according to the embodiment is shown below as an example.

As described above, the amount of learning data required for generating the learning pattern data PD by conventional deep learning processing is ten thousand units. At this time, thousand pieces of learning data are required even in a case where the learning accuracy (determination accuracy) may be lowered. However, in this case, the guarantee that the learning is correctly performed in generating the learning pattern data PD is reduced as much as possible, rather than “the accuracy is lowered”.

On the other hand, the above-described fine-tuning method in which the learning pattern data PD already learned with other learning data (for example, tens of thousands of pieces of image data GD) is learned again with data to be applied is conventionally known. However, even in a case where this method is used, it will be difficult to learn unless there are thousand pieces of image data (at least 1,000 or more).

On the other hand, in an experiment by the present inventors corresponding to the learning processing according to the embodiment, as the image data GD for evaluation, the image data GD of an image in which the deformation of the structure is photographed and specialty is present was used so that the level of the deformation (deterioration) was classified into three levels for recognition. At this time, 30 pieces of image data GD were prepared for each of the levels, and thus evaluation was performed on a total of 90 pieces of image data GD. Note that as a specific accuracy evaluation method, so-called 10-fold cross validation-adopted (90% (81 pieces) image data GD was learned by the learning apparatus L and the remaining 10% (9 pieces) image data GD was used for the deterioration determination processing repeated ten times by the inspection apparatus C). The results of the above experiment are shown in Table 1.

TABLE 1

| | ACCURACY OF | DETERIORATION | |
|---|---|---|---|
| | SUBJECT | DETERMINATION | |
| | (ACCURACY | PROCESSING ACCORDING | Fine- |
| | LIMIT) | TO EMBODIMENT | turting |
| SUBJECT A | 0.78 | 0.68 | 0.43 |
| SUBJECT B | 0.80 | 0.73 | 0.43 |
| SUBJECT C | 0.67 | 0.71 | 0.43 |
| SUBJECT D | 0.74 | 0.67 | 0.43 |
| AVERAGE | 0.75 | 0.70 | 0.43 |

At this time, in Table 1, subjects A to D are asked to cooperate as the acquisition source of the brain activity data as the external data ED, and the deterioration determination result of those persons using the above-described 81 pieces of image data GD, the result of deterioration determination processing according to the embodiment, and the deterioration determination result by the above-described fine-tuning method are described. That is, first, the above-described fine-tuning method has the same determination accuracy (it is displayed as a percentage notation of the correct answer rate in Table 1) regardless of the subjects because the external data BD is not used, but since the number of pieces of image data GD is overwhelmingly smaller than that of the conventional fine-tuning method, the determination accuracy is also less than 50%. On the other hand, the deterioration determination result according to the embodiment has accuracy close to the determination result by the person (subjects A to D) as the accuracy limit. Moreover, in the relationship with the subject C, the accuracy is higher than that of the subject C. Note that the above-described accuracy is not 100% in any of the subjects A to D. However, because among companies and the like that perform deterioration determination using the image data GD, “the final determination result obtained as the most experienced engineers referenced all the data related to the structure (not only the image data GD)” has to be the accuracy limit, the accuracy of the deterioration determination cannot be 100 percent even for a human subject.

### INDUSTRIAL APPLICABILITY

As described above, the present invention can be used in the field of a determination system for determining the state of a structure or the like, and particularly when applied to the field of a determination system for determining the deterioration of the structure or the like, a particularly remarkable effect can be obtained.

### DESCRIPTION OF REFERENCE NUMERALS

1, 10, 20 Input interface
2, 5, 11, 21, 23 Feature amount extraction unit
3 Canonical correlation analysis unit
4, 22 Transformation unit
6 Learning parameter determination unit
7, 26 Storage unit
8 Feature amount selection unit
24 Classification unit
25 Output unit
S Determination system
L Learning apparatus
C Inspection apparatus
GD Image data
BD External data
PD Learning pattern data
GC Image feature data
BC External feature data
LD Label data
RT Analysis result data
MC Transformed image feature data
CT Classification data
MCC Learning feature data
CMC Feature data

1. A learning apparatus generating learning pattern information for outputting significant output information corresponding to input information on the basis of the input information, the learning pattern information corresponding to a result of deep learning processing using the input information, the learning apparatus comprising:
an external information acquisition unit that externally acquires external information corresponding to the input information, the external information being electrically generated due to a person's activity related to the person's recognition of a real object that was the target when the input information was generated, the recognition of the real object being executed separately from the generation of the input information, and the external information being not subjected to correlation processing with other information;
a transformation unit that transforms input feature information on the basis of a correlation between the input feature information indicating a feature of the input information and external feature information indicating a feature of the acquired external information, and generates transformed input feature information; and
a deep learning unit that executes the deep learning processing using the generated transformed input feature information, and generates the learning pattern information.

2. The learning apparatus according to claim 1, wherein
the external information is external information including the information respectively indicating the expertise and the preferences related to the recognition of the person.

3. The learning apparatus according to claim 2, wherein
the external information includes visual recognition information corresponding to a visual recognition action of the person at the time of the person's recognition.

4. The learning apparatus according to claim 3, wherein
the visual recognition information is line-of-sight data showing the movement of the line of sight of the person as the visual recognition action.

5. The learning apparatus according to claim 1, wherein
the correlation is a correlation, which is a result of canonical correlation analysis processing between the input feature information and the external feature information, and
the transformation unit transforms the input feature information on the basis of the result and generates the transformed input feature information.

6. An information output apparatus outputting the output information using the learning pattern information generated by the learning apparatus according to claim 1, the information output apparatus comprising:
a storage unit that stores the generated learning pattern information;
an acquisition unit that acquires the input information; and
an output unit that outputs the output information corresponding to the input information on the basis of the acquired input information and the stored learning pattern information.

7. A learning method executed in a learning apparatus generating learning pattern information for outputting significant output information corresponding to input information on the basis of the input information, the learning pattern information corresponding to a result of deep learning processing using the input information, the learning apparatus including an external information acquisition unit a transformation unit and a deep learning unit, the learning method comprising:
an external information acquisition step of externally acquiring external information corresponding to the input information by the external information acquisition unit the external information being electrically generated due to a person's activity related to the person's recognition of a real object that was the target when the input information was generated, the recognition of the real object being executed separately from the generation of the input information, and the external information being not subjected to correlation processing with other information;
a transformation step of transforming input feature information by the transformation unit on the basis of a correlation between the input feature information indicating a feature of the input information and external feature information indicating a feature of the acquired external information, and generating transformed input feature information; and
a deep learning step of executing the deep learning processing by the deep learning unit using the generated transformed input feature information, and generating the learning pattern information.

8. A non-volatile recording medium recording a program for a learning apparatus for causing a computer included in a learning apparatus generating learning pattern information for outputting significant output information corresponding to input information on the basis of the input information, the learning pattern information corresponding to a result of deep learning processing using the input information, to function as:
an external information acquisition unit that externally acquires external information corresponding to the input information, the external information being electrically generated due to a person's activity related to the person's recognition of a real object that was the target when the input information was generated, the recognition of the real object being executed separately from the generation of the input information, and the external information being not subjected to correlation processing with other information;
a transformation unit that transforms input feature information on the basis of a correlation between the input feature information indicating a feature of the input information and external feature information indicating a feature of the acquired external information, and generates transformed input feature information; and
a deep learning unit that executes the deep learning processing using the generated transformed input feature information, and generates the learning pattern information.

9. An information output method executed in an information output apparatus outputting the output information using the learning pattern information generated by the learning apparatus according to claim 1 the information output apparatus comprising a storage unit that stores the generated learning pattern information, an acquisition unit and an output unit, the information output method comprising
an acquisition step of acquiring the input information by the acquisition unit; and
an output step of outputting the output information corresponding to the input information by the output unit on the basis of the acquired input information and the stored learning pattern information.

10. A non-volatile recording medium recording an information output program for causing a computer included in an information output apparatus outputting the output information using the learning pattern information generated by the learning apparatus according to claim 1, to function as:
a storage unit that stores the generated learning pattern information;
an acquisition unit that acquires the input information; and
an output unit that outputs the output information corresponding to the input information on the basis of the acquired input information and the stored learning pattern information.
